(19) United States
(12) Patent Application Publication
(10) Pub. No.: US 2009/0162630 A1
(43) Pub. Date: Jun. 25, 2009

(54) Biodegradable Heat-Shrinkable Production Method Thereof

(76) Inventor: Young-Su Shin, Gyeonggi-do (KR)

Correspondence Address: Daniel P. Burke, Esq., Daniel P. Burke & Associates, PLLC, 300 Rabro Drive, Suite 131, Hauppauge, NY, 11788, US

(21) Appl. No.: 12/226,882

(22) PCT Filed: Jun. 5, 2006
(86) PCT No.: PCT/KR2006/002159

§ 371 Date: Oct. 31, 2008

(30) Foreign Application Priority Data
May 3, 2006 (KR) 10-2006-0039907

(51) Int. Cl. B32B 27/36; C08L 67/00; C08K 3/34; C08K 3/36; C08K 3/26; C08K 3/30; C08K 3/32; C08K 3/22; C08K 3/04; B29C 47/00

(52) U.S. Cl. 428/220; 525/411; 524/451; 524/539; 524/425; 524/424; 524/423; 524/415; 524/430; 524/447; 264/210.1

(57) ABSTRACT

The present invention relates to a biodegradable heat-shrinkable film for shrinkable label of vessel having printing property, sealable, transparency and superior mechanical property, capable of decomposing in a nature environments, and the present invention provides a biodegradable heat-shrinkable film comprising a biodegradable polylactic acid series polymer and an aliphatic polyester in the weight ratio range of 70:30-95:5.

### TECHNICAL FIELD

The present invention relates to a biodegradable heat-shrinkable film and production a method thereof, and more particularly a biodegradable heat-shrinkable film and a method thereof having superior transparency, printing property, adhesive property for solvent and shrinkage property, as well as naturally decomposition in a nature environment and excellent processability during extrusion process and drawing process.

### BACKGROUND ART

A heat-shrinkable film is variously used in label of a glass bottle, a plastic, a battery, a writing materials etc., and it is required superior properties of a solvent resistance, a heat resistance, a weatherability and the like, in particular superior shrinkage uniform property.

The shrinkable films of the related art using a polystyrene, a polyethyleneterephthalate, a polyvinyl chloride have various problems.

The printing of polystyrene film must use a special ink because the polystyrene film is difficult to use an ink for general plastic due to a bad printing property. In particular, it needed careful attention in the transport and the safekeeping due to a large natural shrinkage ratio.

Although the polyethyleneterephthalate film is superior a heat resistance, a chemical resistance and a weatherability, it is generated various problem in labeling of vessel because of a large shrinkage stress and a fast shrinkage velocity. If the shrinkage stress is large, an accommodation for the contents shrinks because a volume of the plastic vessel is decreased. If the shrinkage velocity is a fast, the value of the goods deteriorates due to the shrinkage irregularity. In addition, a many cost is needed in the separation of the vessel and label in recycling process and it is a many difficult to separate the vessel and label.

In particular, the polyvinyl chloride film have problem that a harmful object such as a hydrogen chloride and dioxin in the incineration disuse exhausts abundantly due to the inclusion of a chlorine component, and thus it is not environment friendly.

Thus, the waste plastic of the film fills in a reclaimed land. However, it induces an obstruction of stabilization of reclaimed land, the reduction of use period and devastation of the soil and so on due to a non-degradable property of the waste plastic. In particular, the abandoned waste plastic in a sea, river, lake and the like becomes a serious harm.

In order to solve a various environmental contamination problem relating to the waste plastic, an interest in a necessity and method of environmental conservation is increased.

Therefore, the study development of environment friendly and harmlessness biodegradable plastic which can use simply as general plastic, and decomposes naturally in a nature environments progresses actively after use.

For example, a polylactic acid is representative. The polylactic acid is hydrolyzed in the earth and is converted into a harmlessness decomposition material by a microorganism.

### DISCLOSURE

### Technical Problem

It is an aspect of the present invention to provide a biodegradable heat-shrinkable film which can prepare easily and can improves a processability, a printing property, a sealable and a transparency.

It is another aspect of the present invention to provide a shrinkable film having superior biodegradable property in reclamation due to a waste.

According to the present invention, the aspects attain to a biodegradable to heat-shrinkable film which is characterized by mixing the aliphatic polyester prepared by ester-polymerization a glycol and dicarboxylic acid to polylactic acid series polymer substrate as biodegradable materials.

### Technical Solution

In general, the polylactic acid prepares by polymerizing a lactic acid which is prepared from a glucose formed by fermentation a corn starch. The present invention uses the polylactic acid series polymers such as 2002D, 3001 D, 3051 D, 4032D, 4060D, 4042D, 7000D (Natureworks Co. Ltd., production) etc., having a weight average molecular weight of 200,000 or more. The polylactic acid series polymer is preferably the mixture of at least two selected from the group consisting of the polymers.

In addition, the aliphatic polyester can be prepared by trans-esterification of glycol and dicarboxylic acid. The glycol is an ethylene glycol, diethylene glycol, triethylene glycol and the like. The present invention is used at least one aliphatic polyester selected from the group consisting of G4260, 4460, 4560, 8060(Ire chemical Ltd. products); PD-150, 350 (DIC Co. product); and ECOFLEX F BX 7011 (BASF the chemical company, product) as products.

The weight ratio of the polylactic acid series polymer and the aliphatic polyester in the present invention is preferably in the range of 70:30˜95:5.

In the present invention, a raw product of the biodegradable film mixed by composition ratio of regular amount extrudes through T dies of coat hanger way as improvement type of T dies of straight type.

T dies is designed, so that an extruder output is unchanged, a resin is discharged to uniform velocity, a dispersion of roll mixing milling is a good and the retention of the biodegradable resin through a heat melting extruder, capable of exhausting a bubble mixing is prevented.

The molder machine for extruding a raw product of film uses uniaxial extruder having a good roll mixing milling of resin more than a biaxial extruder having a uniform the resin exhausting stability and the resin residence time to prepare uniform composition of a mixture of polylactic acid series polymer and the aliphatic polyester.

The biodegradable film having superior shrinkage uniform property and transparency prepares by storing the biodegradable resin melting extruded by T dies with a cooling bath for storing a cooled water in a freezer, and quenching with cooling roll cooled by cycling pump, and followed by passing some guide roll.

When a low molecular material is included in the biodegradable raw product molded by extruding polylactic acid series polymer, the phenomenon is caused by adhering and being united the film by the temperature and press in reeling step due to bleeding the materials by diffusing on the film surface.

Therefore, the present invention may be added 300˜5000 ppm of at least one selected from the group consisting of oleamide, acamide and steaamide compound as the aliphatic acid amide compound, having a melting points of 70˜100° C. to prepare superior biodegradable heat-shrinkable film. In addition, in order to control a blocking prevention, a crystallinity and a velocity of crystallinity, a inorganic particle, for example an amorphous silica(silicon dioxide), talc, zeolite, calcium carbonate, magnesium carbonate, calcium sulfate, calcium phosphate, magnesium phosphate, aluminium oxide, carbon black, titanium dioxide, kaolin and the like, can be used. In particular, silica, talc and zeolite are preferable. The inorganic particle can be added through matter batch in extrusion process. The amount of inorganic particle in the present invention is preferably 1˜5 wt %, and an average particle size is preferably 1˜5 μm, more preferably 2˜3 μm.

The half-crystallinity polymer mixing the polylactic acid series polymer and aliphatic polyester melts and extrudes through above method, and then quenching process performs directly to prepare a noncrystallinity biodegradable raw product capable of drawing.

The desired film thickness is obtained by biting the raw product of the biodegradable film in a clip of the tenter drawing machine, and progressing toward a mechanical direction, and gradually widening a distance of clip space by accelerating a clip for drawing the raw product of the biodegradable film in the transverse direction. The drawing temperature and the drawing ratio are decided by the shrinkage ratio property.

The thickness of film in the present invention is preferably 5˜70 μm, more preferably 15˜50 μm.

The drawing ratio and the temperature control sets up a suitable temperature of melting point or less of the biodegradable raw product so as to improve a mechanical strength, an optical property, a gas transmittancy and shrinkage ratio of the biodegradable film by giving an orientation to a molecular structure and resin crystallinity of drawed middle-degradable raw product.

According to blending ratio of polylactic acid series polymer and aliphatic polyester polymer as a raw product of the biodegradable film, the processing temperature is a different, however, the temperature controls and a wind velocity maintains simultaneously so as to have regular the temperature distribution in pre-heating process.

If the drawing temperature in the drawing process is not regular, the thickness and shrinkage ratio have bad influence of the drawed film due to irregular temperature. If the drawing temperature is a low, there is partially difference between the strength of shrinkage film and shrinkage ratio because a molecular orientation is not uniform to the drawing direction. The shrinkage ratio of TD, MD direction must 5% or less.

According to blending ratio polylactic acid series polymer and aliphatic polyester polymer as the raw product of the biodegradable film, it differs from drawing temperature. In general, a transverse drawing performs at 80˜130° C. The drawing ratio of transverse direction is preferably 2˜6.

Hereinafter, the present invention is described in more detail through examples. However, the following examples are only for the understanding of the present invention and the present invention is not limited to or by them.

### BEST MODE

### Example 1

An amorphous raw product extrusion having desired thickness was prepared by mixing 1 wt % of silicon dioxide having average particle sizes of 2˜2.8 μm to 89 wt % of polylactic acid series polymer (2002D, 3001D, 4032D, 4042D and 4060D) and 10 wt % of aliphatic polyester(G4260) having weight average molecular weight of 200,000 or more, and removing moisture through sufficiently drying, and followed by applying the resultant to extruder of 90 mm at 150˜230° C. (Table 1).

The biodegradable heat-shrinkable film of 15 μm was prepared by applying the raw product prepared by the mixture process and work process to the tenter, pre-heating at 100° C., and drawing in the ratio of 6 times. The property result of the obtained film was shown in Table 2.

### Example 2

The amorphous raw product having desired thickness was prepared by adding 1 wt % of silicon dioxide having average particle sizes of 2˜2.8 μm to 79 wt % of polylactic acid series polymer (4032D, 4042D, 4060D) and 15 wt % of aliphatic polyester(G4260) having weight average molecular weight of 200,000 or more, and removing moisture through drying sufficiently, and followed by applying the resultant to extruder of 90 mm at 150˜230° C. (Table 1).

The biodegradable heat-shrinkable film of 40 μm was prepared by applying the raw product prepared by the mixture process and work process to the tenter, pre-heating at 100° C., and drawing in the ratio of 3 times. The property result of the obtained film was shown in Table 2.

### Example 3

The amorphous raw product having desired thickness was prepared by adding 1 wt % of silicon dioxide having average particle sizes of 2˜2.8 μm to 94 wt % of polylactic acid series polymer (2002D, 3001D, 3051D, 4032D) and 5 wt % of aliphatic polyester(G4260) having weight average molecular weight of 200,000 or more, and removing moisture through drying sufficiently, and followed by applying the resultant to extruder of 90 mm at 150˜230° C. (Table 1).

The biodegradable heat-shrinkable film of 70 μm was prepared by applying the raw product prepared by mixture and the process to tenter, pre-heating at 80° C., and drawing in the ratio of 3 times. The property result of the obtained film was shown in Table 2.

The biodegradable heat-shrinkable film of 70 μm was prepared by applying the raw product prepared by the mixture process and work process to the tenter, pre-heating at 80° C., and drawing in the ratio of 3 times. The property result of the obtained film was shown in Table 2.

### Example 4

The amorphous raw product having desired thickness was prepared by adding 1 wt % of silicon dioxide having average particle sizes of 2˜2.8 μm to 94 wt % of polylactic acid series polymer (2002D, 4060D, 7000D) and 1 wt % of aliphatic polyester(G4060D) having weight average molecular weight of 200,000 or more, and removing moisture through drying sufficiently, and followed by applying the resultant to extruder of 90 mm at 150˜230° C. (Table 1).

The biodegradable heat-shrinkable film of 40 μm was prepared by applying the raw product prepared by the mixture process and work process to the tenter, pre-heating at 80° C., and drawing in the ratio of 3.5 times. The property result of the obtained film was shown in Table 2.

### Example 5

The amorphous raw product having desired thickness was prepared by adding 1 wt % of silicon dioxide having average particle sizes of 2˜2.8 μm to 84 wt % of polylactic acid series polymer (4032D, 4060D, 7000D) and 15 wt % of aliphatic polyester(G4260) having weight average molecular weight of 200,000 or more, and removing moisture through drying sufficiently, and followed by applying the resultant to extruder of 90 mm at 150˜230° C. (Table 1).

The biodegradable heat-shrinkable film of 50 μm was prepared by applying the raw product prepared by the mixture process and work process to the tenter, pre-heating at 80° C., and drawing in the ratio of 3.5 times. The property result of the obtained film was shown in Table 2.

### Example 6

The amorphous raw product having desired thickness was prepared by adding 1 wt % of silicon dioxide having average particle sizes of 2˜2.8 μm to 69 wt % of polylactic acid series polymer (2002D, 3051D, 4032D, 4042D) and 30 wt % of aliphatic polyester(G4260) having weight average molecular weight of 200,000 or more, and removing moisture through drying, sufficiently and followed by applying the resultant to extruder of 90 mm at 150˜230° C. (Table 1).

The biodegradable heat-shrinkable film of 30 μm was prepared by applying the raw product prepared by the mixture process and work process to the tenter, pre-heating at 95° C., and drawing in the ratio of 4 times. The property result of the obtained film was shown in Table 2.

The following test for the film was performed in accordance with the present invention.

(1) Drawing ratio: The drawing ratio is the value obtained by dividing the width of the bitten part of a clip of the tenter subtracted from the width of the obtained film after the traverse drawing by the width of the bitten part of the clip subtracted from the width of the raw product.

Transverse direction drawing ratio=(The film width after drawing−the width that a clip is bitten)/(The sheet width before drawing−the width that a clip bites)

(2) Heat shrinkable ratio: The sample was prepared by cutting the film to transverse and longitudinal direction, inserting Table line of 100 mm in the width and long between two points, immersing the resultant in warm water bath for 30 seconds at 80° C. Then, the dimension of Table line interval was measured, and the heat shrinkable ratio was measured by following equation.

Heat shrinkable ratio (%)=(dimensions before shrinkage−dimensions after shrinkage)/(dimensions before shrinkage)×100

(3) Print property: The degree of peeling was evaluated by a one color printing with gravure printing machine for soft package on the whole surface of the film, drying to 80 m/min, attaching the adhesive tape with adhesive tape of 40 g/mm on the printed surface, taking off adhesive tape and measuring an amounts of peeled printing ink in the adhesive tape.

⊚: The ink printed in the adhesive tape is not peeled.

◯: The ink printed in the adhesive tape peels of 30% or less

x: The ink printed in the adhesive tape peels of 30% or more.

(4) Adhesive property for solvent: An adhesive sate was measured by coating general tetrahydrofuran(THF) as solvent on shrinkage film.

⊚: The moment adhesive property is superior and an adhesive property is maintained continuously.

x: The moment adhesive property is inferior and there is no adhesive property.

(5) The exterior sate after shrinkage: The label was cut to a size of 70 mm in a diameter×125 mm in a length with the prepared shrinkable film, and then the aluminium vessel of 750 ml was packed up to shoulder part. Thereafter, the vessel was immersed in hot water for 30 seconds at 100° C., and the shrinkage badness was measured by repeating shrinkage state of the exterior for 10 times.

⊚: Shrinkage badness noting

◯: Shrinkage badness of 3 or less

x: Shrinkage badness of 3 or more

(6) The film processability: The sample was obtained by cutting the prepared shrinkable film to a size of 100 cm in width×100 cm in long, and the film processability was estimated by measuring the thickness variation, fish eye, and whitening and the like for the sample.

⊚: In the case of thickness variation of ±10% or less of creation thickness, a clear exterior, and a fish eye of 3 or less.

◯: In the case of thickness variation of ±15% or less of creation thickness, a clear exterior, and a fish eye of 3 or less.

x: In the case of thickness variation of ±15% or more of creation thickness, a bad exterior, and a fish eye of 3 or more.

TABLE 1

| | Composition of shrinkable film (wt %) | | | | | | | | |
|---|---|---|---|---|---|---|---|---|---|
| | Polylactic acid series polymer | | | | | | | aliphatic | Silicon |
| | 2002D | 3001D | 3051D | 4032D | 4042D | 4060D | 7000D | polyester | dioxide |
| Example 1 | 9 | 10 | | 15 | 15 | 40 | | 10 | 1 |
| Example 2 | | | | 29 | 10 | 40 | | 15 | 1 |
| Example 3 | 10 | 5 | 55 | 24 | | | | 5 | 1 |
| Example 4 | 10 | | | | | 19 | 65 | 5 | 1 |
| Example 5 | | | | 25 | | 54 | 5 | 15 | 1 |
| Example 6 | 9 | | 10 | 10 | 40 | | | 30 | 1 |

TABLE 2

| | | Tensile | | Adhesive | | Shrinkage ratio | |
|---|---|---|---|---|---|---|---|
| | Film | strength | Printing | property for | Shrinkage | (100° C. water) | |
| | processability | (kg/cm³) | property | solvent | state | MD | TD |
| Example 1 | ◯ | 2000 or | ⊚ | | ⊚ | 6 | 75 |
| | | more than | | | | | |
| Example 2 | ⊚ | 2000 or | ⊚ | ⊚ | ◯ | 5 | 48 |
| | | more than | | | | | |
| Example 3 | ⊚ | 2000 or | ⊚ | ⊚ | ◯ | 5 | 51 |
| | | more than | | | | | |
| Example 4 | ◯ | 2000 or | ⊚ | ⊚ | ⊚ | 5 | 45 |
| | | more than | | | | | |
| Example 5 | ◯ | 2000 or | ⊚ | ⊚ | ⊚ | 7 | 75 |
| | | more than | | | | | |
| Example 6 | ⊚ | 2000 or | ⊚ | ⊚ | ◯ | 9 | 63 |
| | | more than | | | | | |

⊚: Superior, ◯: Good, X: Badness

The present invention is easy to prepare the film and can be obtained a biodegradable heat-shrinkable film improved a processability, printing property, sealable and transparency.

1. Biodegradable heat-shrinkable film, characterized in that the polylactic acid series polymer having a weight average molecular weight of 200,000 or more and the aliphatic polyester is mixed in the weight ratio range of 70:30˜95:5, and 600-5000 ppm of an apliphatic acid amide compound and 1˜5 wt % of an inorganic particles into the mixture is added.

2. The biodegradable heat-shrinkable film of claim 1, wherein the apliphatic acid amide compound is at least one selected from the group consisting of oleamide, acamide and steaamide compound.

3. The biodegradable heat-shrinkable film of claim 1, wherein the inorganic particles is at least one selected from the group consisting of amorphous silica(silicon dioxide), talc, zeolite, calcium carbonate, magnesium carbonate, calcium sulfate, calcium phosphate, magnesium phosphate, aluminium oxide, carbon black, titanium dioxide, kaolin.

4. The biodegradable heat-shrinkable film of claim 1, wherein the inorganic particles have an average particle sizes of 1˜5 μm.

5. The biodegradable heat-shrinkable film of claim 1, wherein the thickness of the film are present in the range of 5˜70 μm.

6. The biodegradable heat-shrinkable film of claim 1, wherein the drawing ratio of transverse direction(TD) of the film is 2˜6 and the shrinkage ratio of machine direction(MD) is 5% or less.

7. A method for preparing the biodegradable heat-shrinkable film comprising the steps of:
blending the polylactic acid series polymer having weight average molecular weight of 200,000 or more and the aliphatic polyester,
adding the aliphatic acid amide compound and the inorganic particles,
extruding the blending-mixture through film dies to obtain raw product for the film,
cooling the obtained product with cooling roll,
pre-heating the obtained product at 80˜100° C., and
drawing the product by transverse direction in drawing ratio of 2˜6 at 80˜130° C. to prepare the biodegradable heat-shrinkable film.

8. (canceled)

9. (canceled)

10. (canceled)

11. (canceled)
